(19) United States
(12) Patent Application Publication
(10) Pub. No.: US 2008/0117897 A1
(43) Pub. Date: May 22, 2008

(54) EXTERNAL DATA ACCESS INFORMATION IN A VOIP CONVERSATION

(75) Inventors: Linda Criddle, Kirkland, WA (US); David Milstein, Redmond, WA (US); Lon-Chan Chu, Redmond, WA (US); Kuansan Wang, Bellevue, WA (US); Michael D. Malueg, Renton, WA (US); Timothy M. Moore, Bellevue, WA (US); Philip A. Chou, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MICROSOFT CORPORATION, Redmond, WA (US)

(21) Appl. No.: 11/562,935

(22) Filed: Nov. 22, 2006

(51) Int. Cl. H04L 12/56

(52) U.S. Cl. 370/389

(57) ABSTRACT

A method and system provides the ability to share access information for external data over a digital voice communication channel. The access information of external data may be exchanged instead of the external data itself. More specifically, a recipient device may receive contextual information which relates to the access information of external data. The contextual information may be processed to identify the source of the external data and other information necessary to access the external data. For example, a hyperlink directed to the external data in a Web server may be exchanged while the recipient device and the sending device are involved in a digital conversation. The recipient device can access the external data by activating the hyperlink.

### BACKGROUND

Generally described, an Internet telephony system provides an opportunity for users to have a call connection with enhanced calling features compared to a conventional Public Switched Telephone Network (PSTN) based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. However, current VoIP approaches may not provide the ability to share access information for external data which is stored by a third party of a VoIP call in such a way that the external data can be accessed without burdening the bandwidth of a VoIP communication channel.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method and system provides the ability to share access information which provides information for access to external data over a digital voice communication channel. The access information for external data may be exchanged instead of the external data itself. More specifically, a recipient device may receive contextual information which includes the access information for external data. The contextual information may be processed to identify the source of the external data and other information necessary to access the external data. For example, a hyperlink directed to the external data in a Web server may be exchanged while the recipient device and the sending device are involved in a digital conversation. The recipient device can access the external data by activating the hyperlink.

In accordance with an aspect of the invention, a method for utilizing contextual information to share the external data access information is provided. The method includes receiving contextual information over a digital conversation, which relates to locating and retrieving the external data and processing the contextual information to obtain the external data. Upon processing of the contextual information, a source for the external data may be identified. A user may be prompted to provide user input instructing the recipient device which action to execute. Based on the user input, the external file may be accessed and obtained.

In accordance with another aspect of the present invention, a computer-readable medium having computer-executable components for sharing the external data access information is provided. The computer-executable components include a communication component, a user interface component, and a processing component. The communication component obtains contextual information relating to the external data access information. The processing component identifies a set of rules relating to the obtained contextual information and processes the obtained contextual information based on the set of rules. It is determined whether an appropriate application to process the external data is available. If the appropriate application is available, the external data is retrieved from a source and the appropriate application is applied to the external data.

In accordance with yet another aspect of the invention, a method for a client to obtain the external data via a minimum set of information exchanged over a digital voice conversation is provided. A client transmits and/or receives a minimum set of information which will be utilized to obtain certain external data from a proper source. In addition, the received minimum set of information can be forwarded from one device to a different device which is most appropriate to process the external data.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIG. 4 is a block diagram illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A and 7B are block diagrams illustrating interactions between two clients for collecting and transferring the access information for external data in accordance with an aspect of the present invention;

FIGS. 8A-8F are block diagrams illustrative of various attributes and classes of structured hierarchies corresponding to VoIP contextual information in accordance with an aspect of the present invention;

FIG. 9 is a flow diagram illustrating a contextual data processing routine for sharing the access information for certain external data with an aspect of the present invention; and

FIG. 10 is a flow diagram illustrating a file obtaining subroutine utilized by the contextual data processing routine in FIG. 9 for obtaining the external data accordance with a set of rules in accordance with an aspect of the present invention.

### DETAILED DESCRIPTION

Generally described, the present invention relates to a method and system for providing the ability to share access information for certain “external data” over a VoIP communication channel. “External data,” as used herein, is a set of data, including a file, a Web page, and an application, etc., stored in a third party of the VoIP communication channel. More specifically, the present invention relates to a method and system for receiving and processing access information in order to obtain the corresponding external data while VoIP devices are exchanging a digital conversation which includes voice information, media information and contextual information. For example, the access information for the external data is transmitted as part of contextual information, which is defined in accordance with its corresponding “structured hierarchies.” “Structured hierarchies,” as used herein, are predefined organizational structures for arranging contextual information to be exchanged between two or more VoIP devices. For example, structured hierarchies may be eXtensible Markup Language (XML) namespaces. Further, a VoIP conversation includes one or more data streams of information related to a conversation, such as contextual information and voice/multimedia information, exchanged over a conversation channel. Although the present invention will be described with relation to illustrative structured hierarchies and an IP telephony environment with an emphasis on voice communication, one skilled in the relevant art will appreciate that the disclosed embodiments are illustrative in nature and should not be construed as limiting.

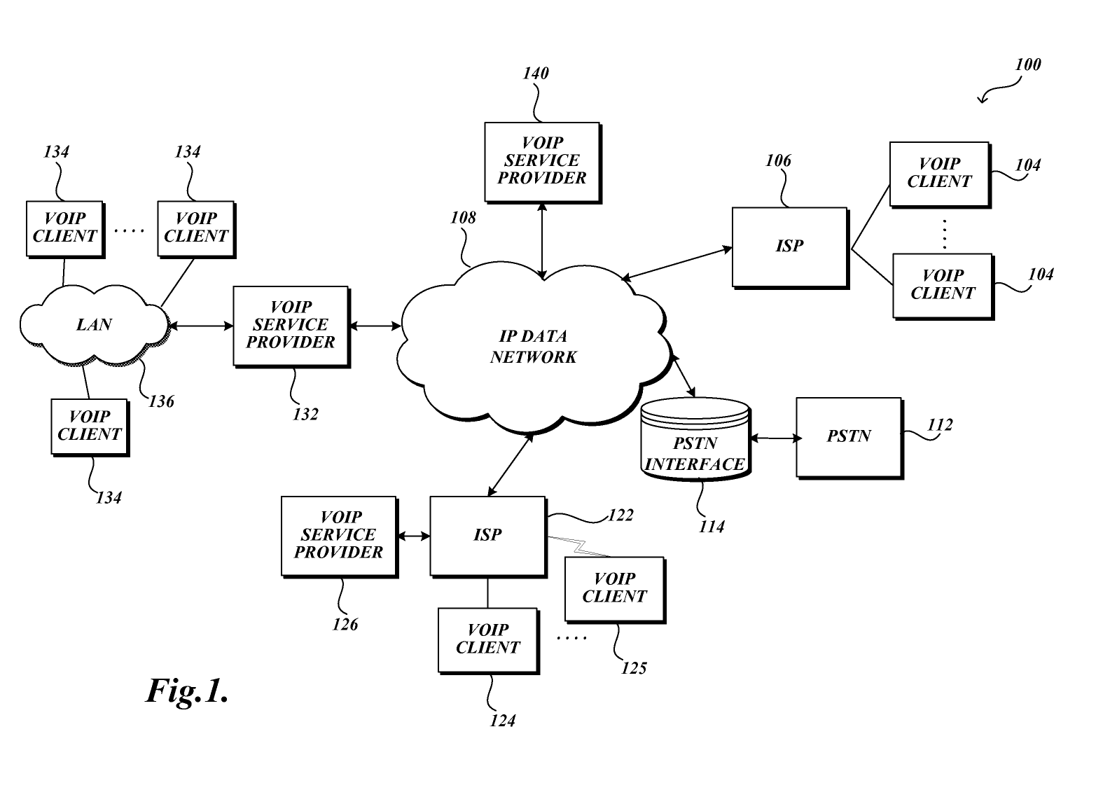

With reference to FIG. 1, a block diagram of an IP telephony environment 100 for providing IP telephone services between various “VoIP clients” is shown. A “VoIP client,” as used herein, refers to a particular contact point, such as an individual, an organization, a roBOT (BOT), a company, etc., one or more associated VoIP devices and a unique VoIP client identifier. For example, a single individual, five associated VoIP devices and a unique VoIP client identifier collectively make up a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN), and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 134 may create, maintain, and provide information relating to predetermined priorities for incoming calls.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with the PSTN 112. A PSTN interface 114 such as a PSTN gateway may provide access between PSTN 112 and the IP data network 108. The PSTN interface 114 may translate VoIP data packets into circuit switched voice traffic for PSTN 112 and vice versa.

Conventional voice devices, may request a connection with the VoIP client based on the unique VoIP identifier of that client, and the appropriate VoIP device associated with the VoIP client will be used to establish a connection. In one example, an individual associated with the VoIP client may specify which devices are to be used in connecting a call based on a variety of conditions (e.g., connection based on the calling party, the time of day, etc.).

It is understood that the above-mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

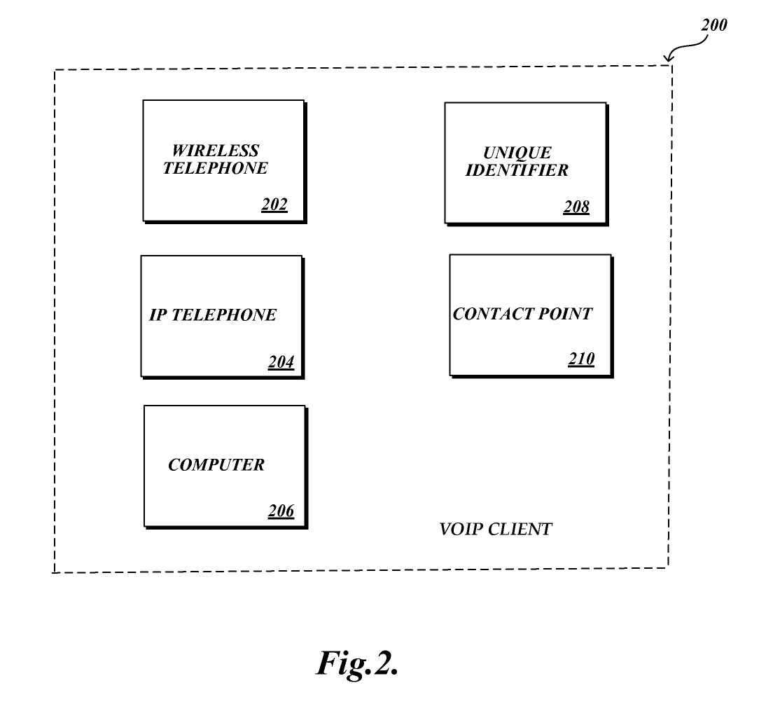

Referring now to FIG. 2, a block diagram illustrating an exemplary VoIP client 200 that includes several VoIP devices and a unique VoIP identifier, in accordance with an embodiment of the present invention, is shown. Each VoIP device 202, 204, 206 may include a storage that is used to maintain voice messages, address books, client specified rules, priority information related to incoming calls, etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique VoIP identifiers 208. The unique VoIP identifier(s) 208 may be constant or change over time. The unique VoIP identifier is used to identify the client and to connect with the contact point 210 associated with the VoIP client. The unique VoIP identifier may be maintained on each VoIP device included in the VoIP client and/or maintained by a service provider that includes an association with each VoIP device included in the VoIP client. In the instance in which the unique VoIP identifier is maintained by a service provider, the service provider may include information about each associated VoIP device and knowledge as to which device(s) to connect for incoming communications. In an alternative embodiment, the VoIP client 200 may maintain multiple VoIP identifiers where a unique VoIP identifier may be temporarily assigned to the VoIP client 200 for each call session.

The unique VoIP identifier may be used similar to a telephone number in PSTN. However, instead of dialing a typical telephone number to ring a specific PSTN device, such as a home phone, the unique VoIP identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

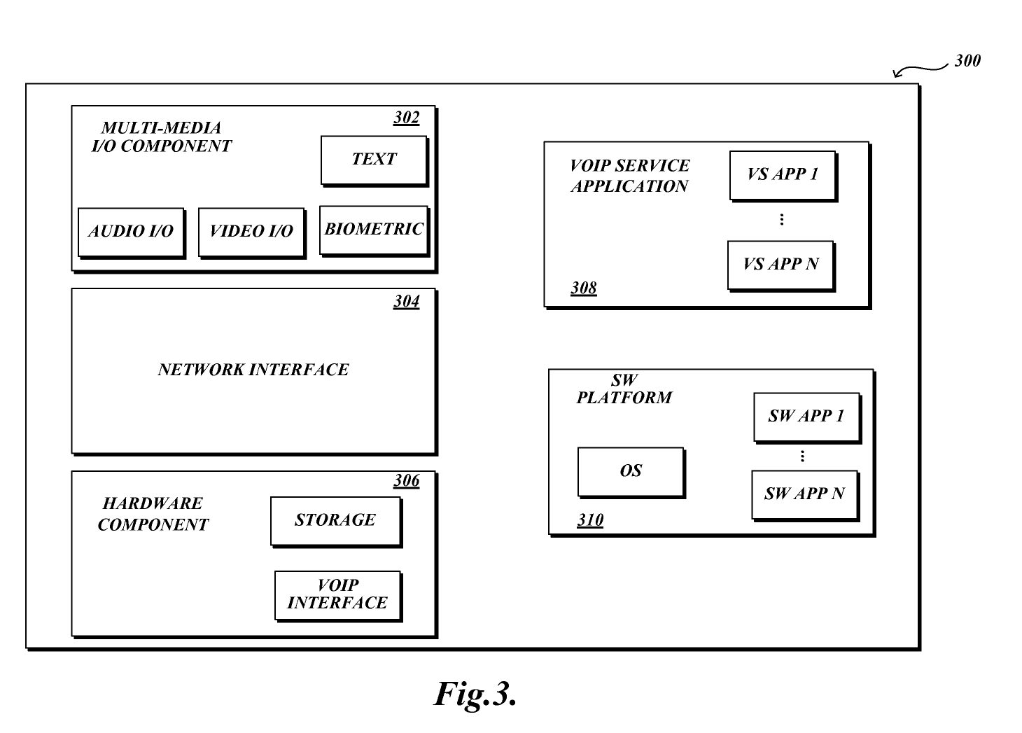

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304.

The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices, and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles, user biometrics information, etc.) associated with the VoIP client in which the device is included. In one embodiment, the hardware component 306 may include a VoIP interface card which allows a non-VoIP client device to transmit and receive a VoIP conversation.

The VoIP device 300 may further include a software platform component 310 for the operation of the VoIP device 300 and a VoIP service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

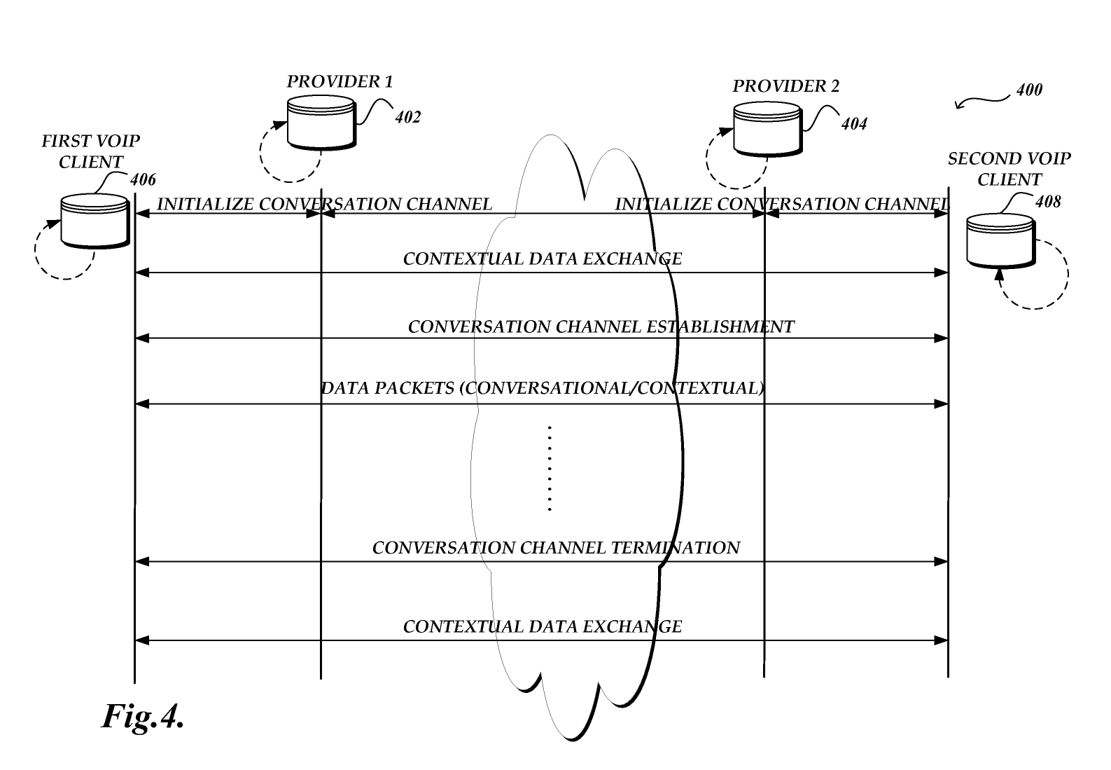

It is to be noted that FIGS. 4, 5, and 6 are depicted herein to discuss general VoIP conversation channel implementation which is utilized when access information for obtaining external data is exchanged as part of contextual information.

With reference to FIG. 4, a block diagram illustrative of a conversation flow 400 between VoIP devices of two different VoIP clients over a conversation channel in accordance with an embodiment of the present invention is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 408. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer-to-peer context, communication between VoIP devices may also be direct without having any service providers involved.

There is a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over a Real-Time Transport Protocol (RTP) path/channel. For the purpose of discussion, a communication channel, as used herein, generally refers to any type of data or signal exchange path/channel. Thus, it will be appreciated that, depending on the protocol, a connection set-up phase and a connection termination phase may require additional steps in the conversation flow 400.

For ease of explanation, we will utilize the example in which the first VoIP client 406 and the second VoIP client 408 each include only one VoIP device. Accordingly, the discussion provided herein will refer to connection of the two VoIP devices. The individual using the device of the first VoIP client 406 may select or enter the unique identifier of the client that is to be called. Provider 1 402 receives the request from the device of the first VoIP client 406 and determines a terminating service provider (e.g., Provider 2 404 of the second VoIP client 408) based on the unique client identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. For example, contextual information may include the access information for a particular electronic document so that the first VoIP client 406 and the second VoIP client 408 can access the electronic document during the conversation. As will be discussed in greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client (e.g., the first VoIP client 406), the device, and the VoIP client (e.g., the second VoIP client 408) being called. For example, the contextual information sent from the called VoIP client may include the access information (e.g., link information) for certain external data (e.g., an electronic document, a Web page, etc., stored in a Web server). In this way, the calling VoIP client can access the external data directly from the Web server. Consequently, the need to exchange the electronic document between the calling VoIP client and the called VoIP client may be eliminated and the bandwidth of the communication channel may not be overloaded by transferring the electronic document.

Available media types, rules of the calling client, the client being called, and the like may also be part of the contextual information that is exchanged during the connection set-up phase. The contextual information may be processed and collected by one of the devices of the first VoIP client 406, one of the devices of the second VoIP client 408, and/or by the VoIP service providers (e.g., Provider 1 402 and Provider 2 404), depending on the nature of the contextual information. In one embodiment, the VoIP service providers 402, 404 may add/delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail below, the data packets, including conversation data packets and contextual data packets, are communicated over the established conversation channel between the connected devices.

Conversation data packets carry data related to a conversation, for example, a voice data packet or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

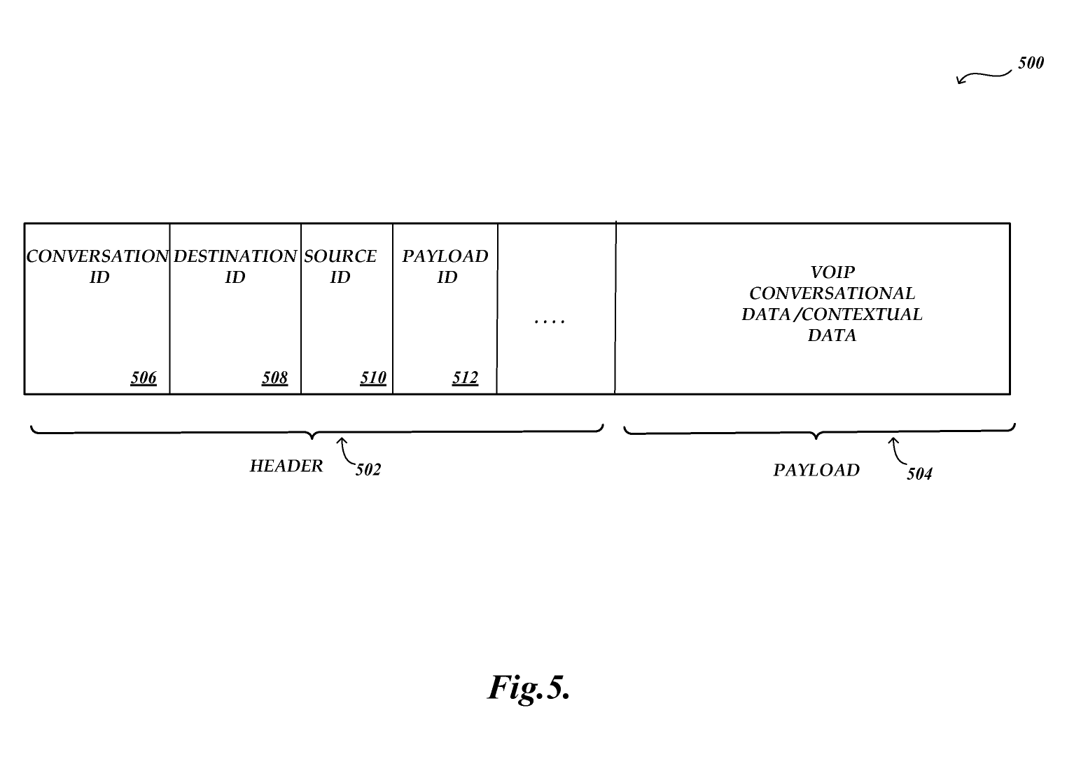

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique VoIP identifier of the client being called, a Source ID 510 (unique VoIP identifier of the calling client or device identifier), Payload ID 512 for identifying the type of payload (e.g., conversation or contextual), individual ID (not shown) for identifying the individual to which the conversation data is related, and the like. In an alternative embodiment, the header 502 may contain information regarding Internet protocol versions, and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context), and the like. More specifically, the contextual information may include client preference, client rules, client's location (e.g., user location, device location, etc.), biometrics information, the client's confidential information, VoIP device's functionality, VoIP service provider's information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify and/or delete the VoIP client's contextual data before forwarding the contextual information. For example, the client's confidential information will be deleted by the VoIP service provider associated with that client unless the client authorizes such information to be transmitted. In some cases, a minimal amount of contextual information is transmitted outside of an intranet network.

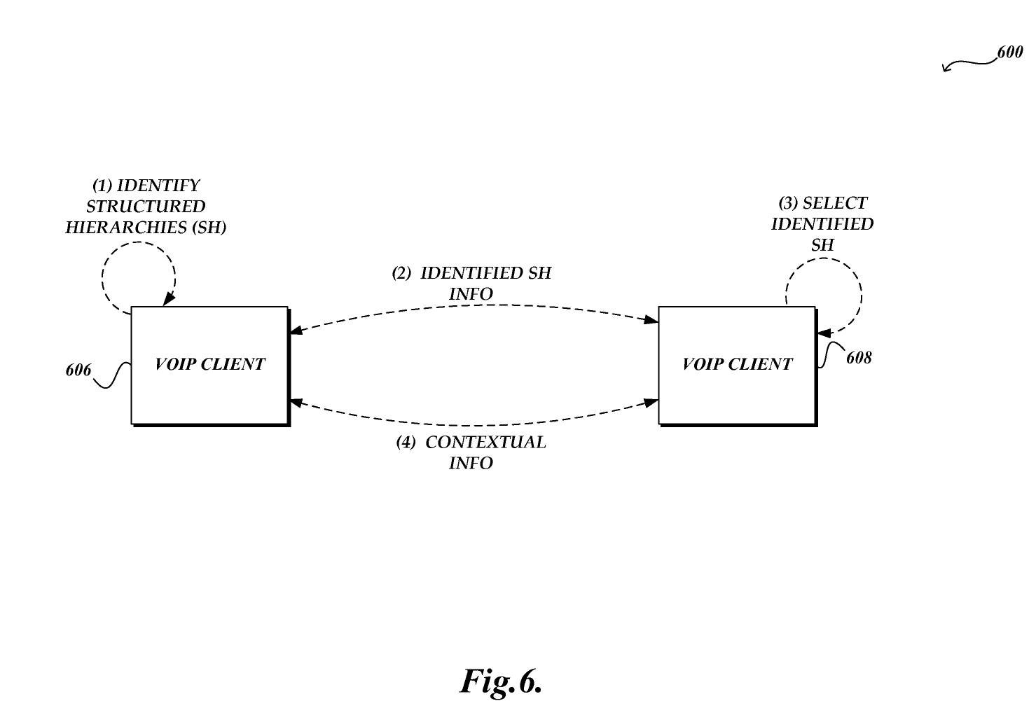

With reference to FIG. 6, a block diagram 600 illustrating interactions between two VoIP clients for transferring contextual information, in accordance with an embodiment of the present invention, is shown. As with FIG. 4, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information identifying which structured hierarchy will be used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchies, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

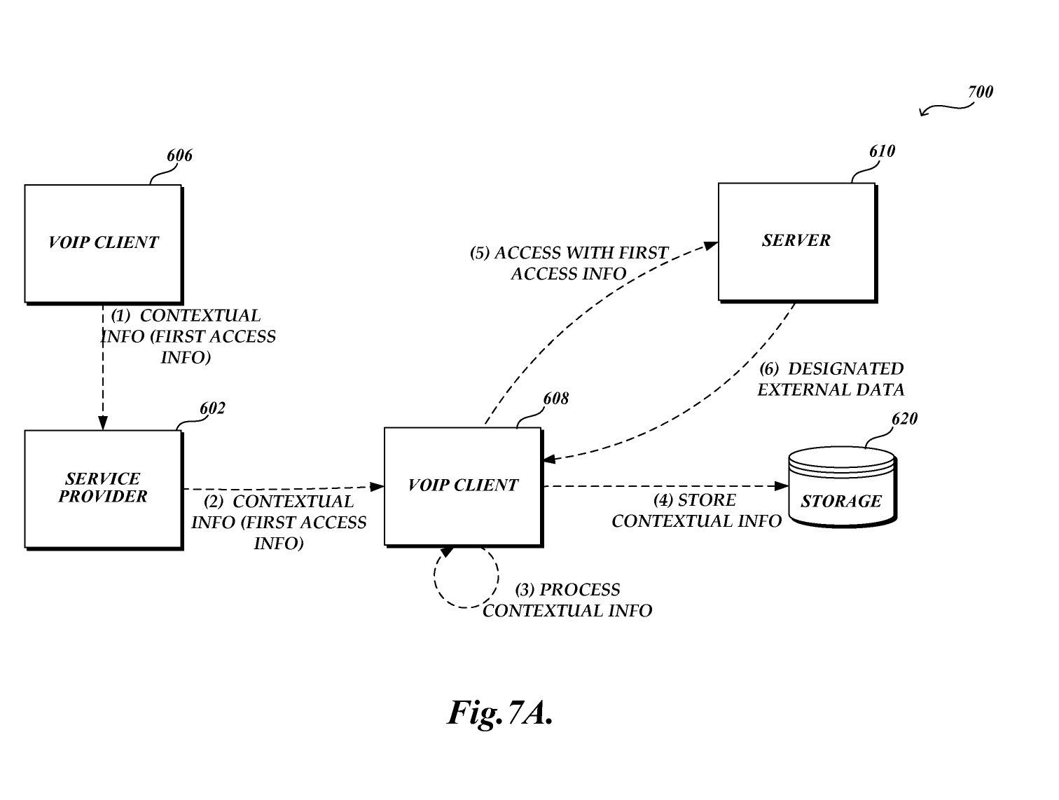

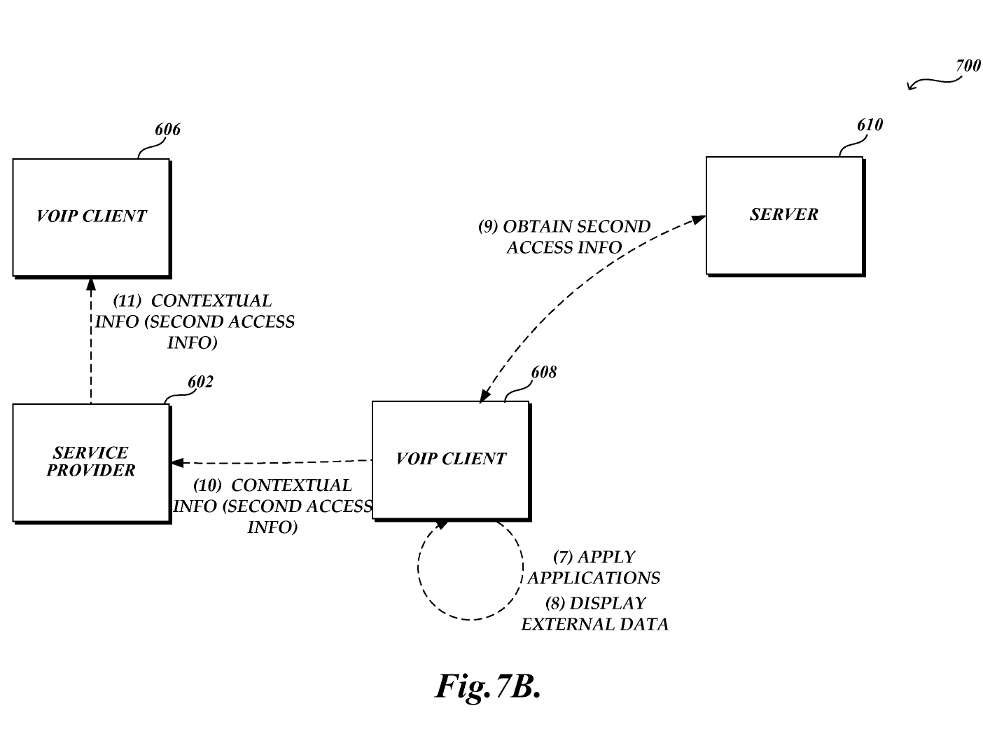

FIGS. 7A and 7B are block diagrams 700 illustrating interactions among several VoIP entities for collecting and transferring the access information for external data via various service providers in accordance with an embodiment of the present invention. The VoIP entities may include VoIP clients 606, 608, a VoIP service provider 602, and the like. While this example utilizes one VoIP service provider, two VoIP clients, and one third party, any number and combination of VoIP clients and/or service providers may be used with embodiments of the present invention. It is also contemplated that collecting and transferring contextual information can be done numerous times before, during, and/or at the end of the conversation.

For discussion purposes, assume that VoIP Client 606 and VoIP Client 608 have established a conversation channel between devices of VoIP Client 606 and VoIP Client 608 via Service Provider (SP) 602 and VoIP Client 606 and VoIP Client 608 are authorized to access a third party (SERVER) 610. Further assume that VoIP Client 606 may collect the minimum information necessary for VoIP Client 608 to obtain external data from the SERVER 610 and instead of transmitting the entire external data, VoIP Client 606 transmits the collected access information to VoIP Client 608 as part of contextual information.

Referring to FIG. 7A, during a conversation, VoIP Client 606 collects contextual information related to first access information for particular external data which VoIP Client 606 wishes to share with VoIP Client 608. VoIP Client 606 identifies structured hierarchies that will be used to carry the contextual information related to the first access information. The collected contextual information is transmitted from VoIP Client 606 to SP 602. Upon receipt of the contextual information, SP 602 may store part or all of the received contextual information and may collect more contextual information, if necessary. SP 602 also updates the received contextual information. In addition, the information regarding the identified structured hierarchies is also transmitted from VoIP Client 606 to SP 602. As will be discussed in greater detail below, the information regarding the identified structured hierarchy may include information about which structured hierarchies are used to carry the corresponding contextual information, how to identify the structured hierarchies, and the like.

SP 602 transmits the contextual information relating to the first access information to VoIP Client 608. SP 602 also transmits information of the corresponding structured hierarchies. VoIP Client 608 may identify a set of rules defining how to process the contextual information upon receipt of the contextual information. In one embodiment, VoIP Client 608 may have a predefined set of rules for each device of VoIP Client 608. Based on the set of rules, VoIP Client 608 may process the contextual information and extract the first access information from the processed contextual information. VoIP Client 608 may also store the contextual information in local storage 620 of one of devices of VoIP Client 608. VoIP Client 608 may access the SERVER 610 with the first access information. Subsequently, the designated external data may be obtained from the SERVER 610.

For purposes of discussion, assume a scenario where Bob and Sarah are discussing an upcoming presentation over a digital voice conversation. Bob has presentation material which was created for another presentation but Bob believes that most part of the presentation material can be reused. The presentation material is stored in a company's data server. Bob sends the access information for the presentation material to Sarah over the digital voice conversation. Upon receipt of the access information for the presentation material, Sarah uses the access information to obtain the presentation material from the company's data server.

Referring now to FIG. 7B, VoIP Client 608 receives user input which may instruct some actions to be executed. In an illustrative embodiment, it may not be desirable to have the external data presented on the device which is currently used for a digital voice conversation. Instead, it may be desirable to have the external data forwarded to other devices of VoIP Client 608. Returning back to the above mentioned example, upon receipt of the access information for the presentation material, Sarah can access the data server utilizing another device, for example, a PC. In this manner, Sarah can have the presentation material displayed on the PC's monitor while a phone is in use for a digital conversation.

In one embodiment, the access information may be a representation of the source of the external data which enables devices of VoIP Clients 606, 608 to immediately access the external data. For example, the access information may include a shortcut link to receive the external data from the SERVER 610 and a device of VoIP Client 608 may currently be connected with the SERVER 610. In this example, upon receipt of the access information, an icon (corresponding to the shortcut link) may be displayed on the device of VoIP Client 608. If the icon is selected, the external data is obtained from the SERVER 610. In some instances, the device of VoIP Client 608 is not currently connected to the SERVER 610. In such instances, the access information, including file name, file path, and file type of the external data stored in the SERVER 610, may be provided to the device of VoIP Client 608. In order to access the external data, the device of VoIP Client 608 contacts the SERVER 610 and requests a retrieval of the external data based on the access information.

After obtaining the external data, an appropriate application may be identified and applied to the external data to produce a proper output for a user interface. VoIP Client 608 may also provide second access information for other external data stored in the SERVER 610 to VoIP Client 606 via SP 602. VoIP Client 608 may collect the second access information from the SERVER 610 and send the second access information to VoIP Client 606 via SP 602. VoIP Client 606 processes the second access information and obtains the corresponding external data from the SERVER 610.

Returning to the presentation example, after viewing the presentation material, Sarah finds a photo file (i.e., external data) in the company data server, which can be a part of the agenda. Sarah wishes to share the photo file with Bob to have his opinion without transferring the photo over the digital conversation. Sarah sends to Bob the access information of the photo file. The access information includes information necessary to locate and retrieve the photo file from the company data server. Upon receipt of the access information, Bob may access the photo file from the data server. In this manner, the photo file can be shared without being exchanged over the digital conversation.

As discussed above, the information regarding the identified structured hierarchies corresponding to the contextual information may be received by VoIP Client 608. Upon receipt of the information regarding the identified structured hierarchies, VoIP Client 608 may look up predefined structured hierarchies to select the identified structured hierarchies for the contextual information. In one embodiment, the structured hierarchies may be defined by XML. However, it is to be appreciated that the structured hierarchies can be defined by any language suitable for implementing and maintaining extensible structured hierarchies. Generally described, XML is well known as a cross-platform, software and hardware independent tool for transmitting information. Further, XML maintains its data as a hierarchically structured tree of nodes, each node comprising a tag that may contain descriptive attributes. XML is also well known for its ability to allow extendable (i.e., vendor customizable) patterns that may be dictated by the underlying data being described without losing interoperability. Typically, an XML namespace URI is provided to uniquely identify a namespace. In some instances, the namespace may be used as a pointer to a centralized location containing default information (e.g., XML Schema) about the document type the XML is describing.

In an illustrative embodiment, VoIP Client 606 may identify an XML namespace for contextual information. When multiple contexts are aggregated, an appropriate XML namespace(s) can be declared as an attribute at the corresponding tags. It is to be understood that XML namespaces, attributes, and classes illustrated herein are provided merely as an example of structured hierarchies used in conjunction with various embodiments of the present invention. After VoIP Client 608 receives the XML namespace information, the VoIP Client 606 transmits a set of data packets containing contextual information defined in accordance with the identified XML namespace or namespaces to VoIP Client 608. When a namespace is present at a tag, its child elements share the same namespace, in pursuant to the XML scope rule defined by the XML 1.0 specification. As such, VoIP Client 608 and VoIP Client 606 can transmit contextual information without including prefixes in all the child elements, thereby reducing the amount of data packets transmitted for the contextual information.

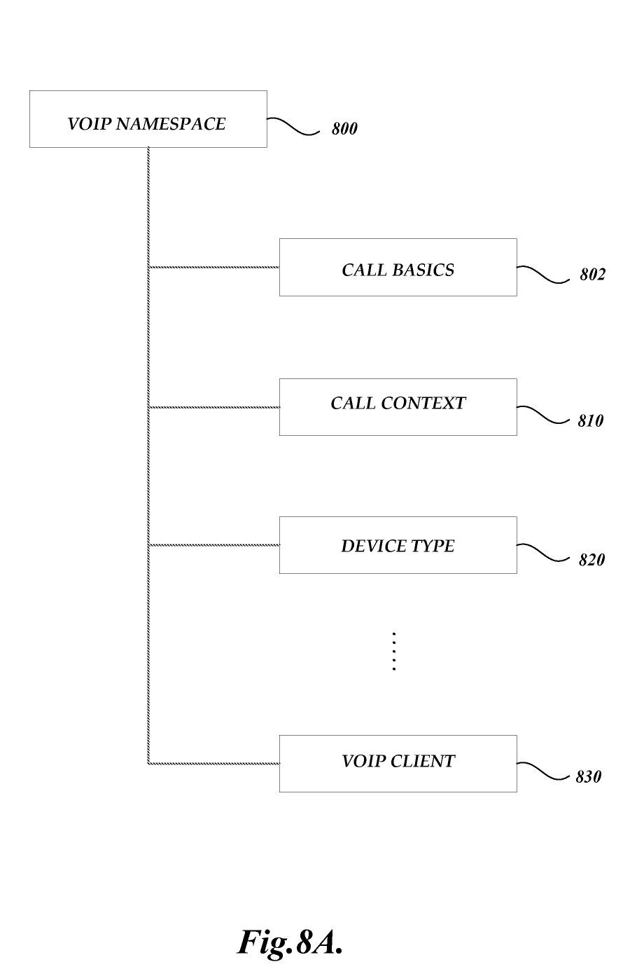

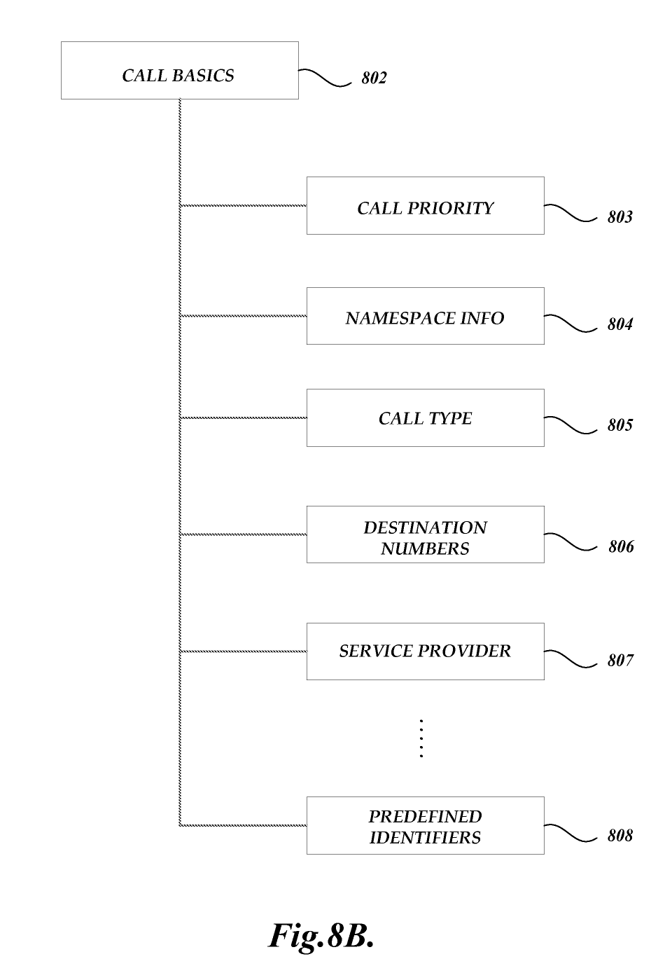

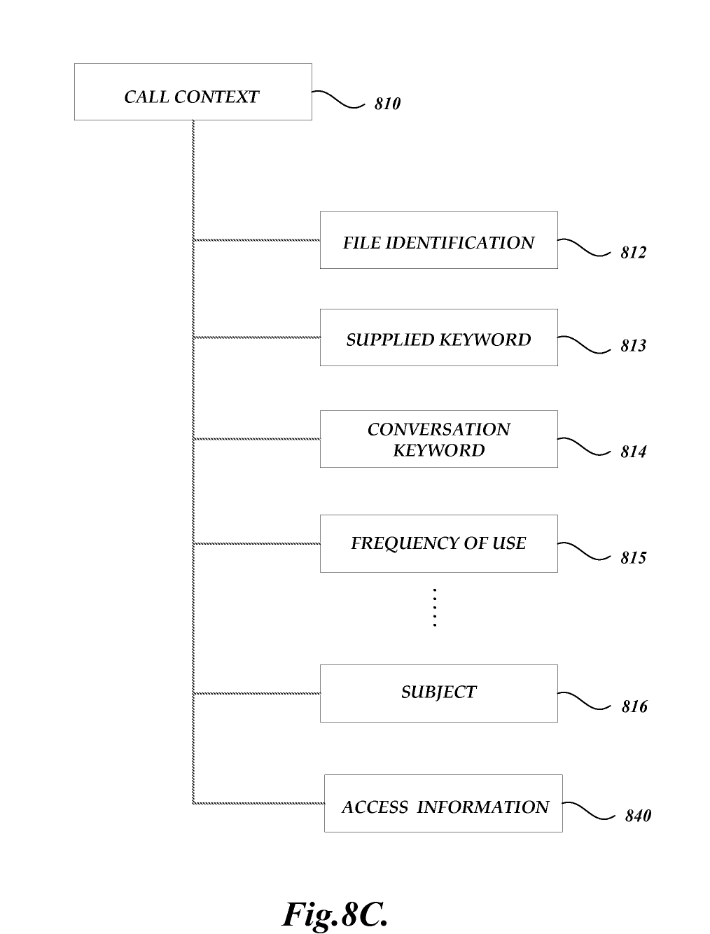

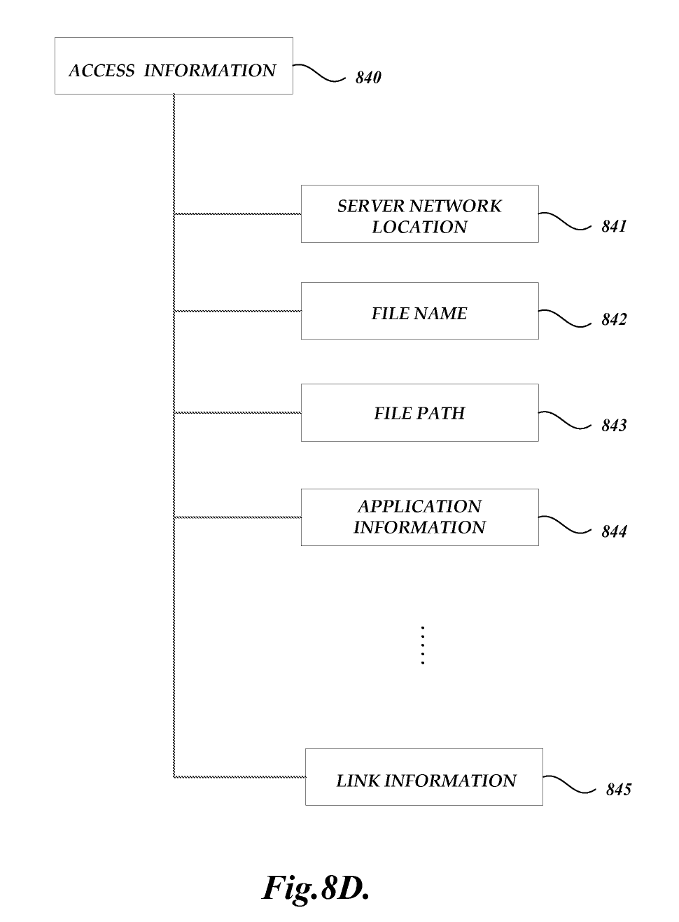

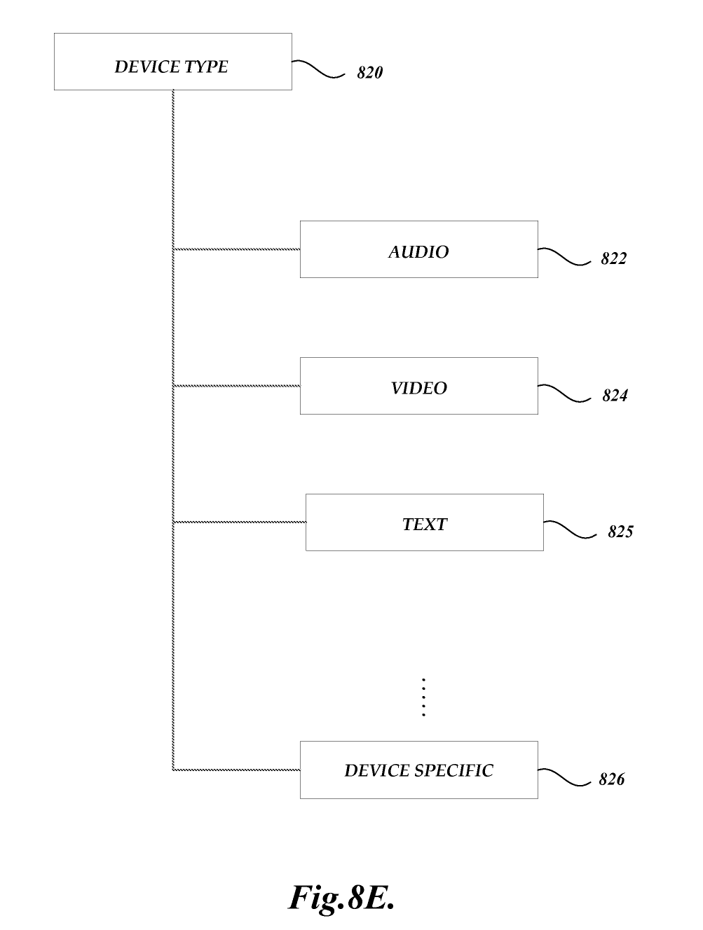

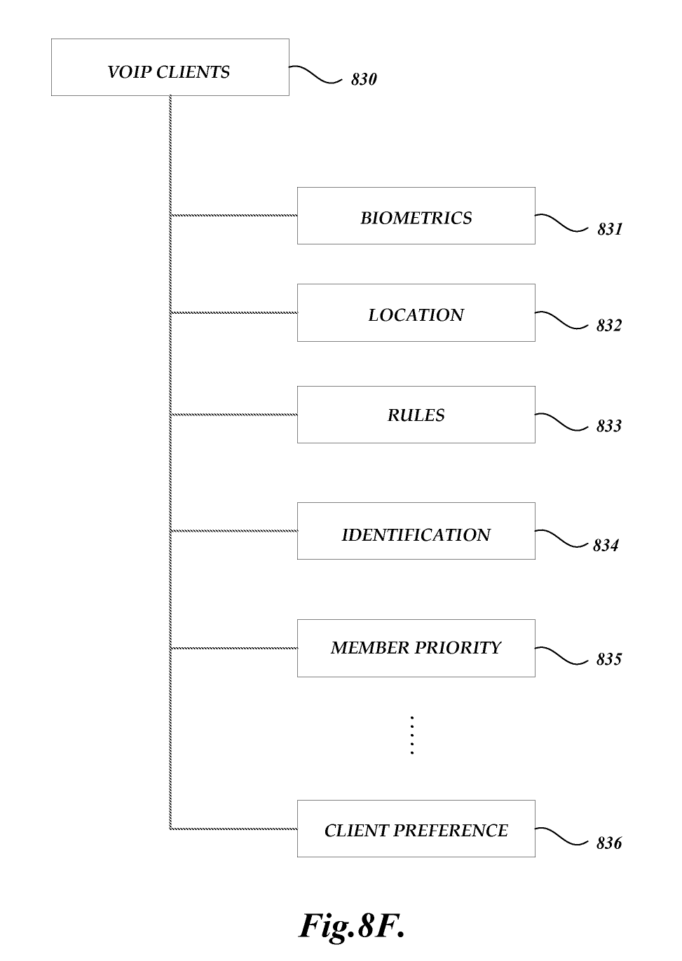

With reference to FIGS. 8A-8F, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a call basics class 802, a call contexts class 810, a device type class 820, a VoIP client class 830, and the like.

With reference to FIG. 8B, a block diagram of a call basics class 802 is shown. In an illustrative embodiment, call basics class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's client ID number), destination numbers (e.g., callees' client ID numbers or telephone numbers), call connection time, VoIP service provider related information, and/or ISP related information such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer-to-computer communication, a computer to POTS device communication, and so forth. In one embodiment, the contextual information relating to a conversation channel connection may include predefined identifiers that represent emotions, sounds (e.g., “ah,” “oops,” “wow,” etc.) and facial expressions in graphical symbols. In one embodiment, a call basics class 802 may be defined as a sub-tree structure of a VoIP namespace 800 that includes nodes such as call priority 803, namespace information 804, call type 805, destination numbers 806, service provider 807, predefined identifiers 808, and the like.

With reference to FIG. 8C, a block diagram of a call contexts class 810 is shown. In one embodiment, a subset of VoIP contextual information relating to conversation context may correspond to the call contexts class 810. The contextual information relating to conversation context may include information such as keywords supplied from a client, a service provider, a network, etc. The contextual information relating to conversation context may also include identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. As mentioned above, the contextual information relating to conversation context may include access information of external data which is utilized to retrieve the external data from a third-party of a communication channel. In accordance with an illustrative embodiment, a call contexts class 810 may be defined as a sub-tree structure of a VoIP namespace 800 that includes nodes corresponding to file identification 812, supplied keyword 813, conversation keyword 814, frequency of use 815, subjects of the conversation 816, access information 840, and the like.

With reference to FIG. 8D, a block diagram of an access information subclass 840 is illustrated. In one embodiment, the access information subclass 840 may correspond to a subset of a call contexts class 810, used for providing information relating to locate, retrieve, and/or obtain external data stored in a third party of the conversation channel connection. For example, the third party may be a server that VoIP clients can have access to during a conversation with each other. The access information subclass 840 may include server information such as network location information of the server, an IP address of the server, etc. Further, the information relating to the external data stored in the server, such as a file (electronic document) name containing the external data, a file type (text, audio, multimedia), a file path (file's corresponding location in a file system), etc., may be included. The access information subclass 840 may also include link information such as a hyperlink of the external data, a shortcut link of the external data, or the like, which is activated by clicking on its corresponding highlighted text or an icon on a display screen. In addition, the access information subclass 840 may include the information of an appropriate application to open the file containing the external data.

In an illustrative embodiment, an access information subclass 840 may be defined as a subtree structure of a call contexts class 810 that includes nodes corresponding to server network location 841, a file name 842, a file path 843, application information 844, link information 845, and the like.

With reference to FIG. 8E, a block diagram of a device type class 820 is depicted. In one embodiment, a device type class 820 may correspond to a subset of VoIP contextual information relating to a VoIP client device (e.g., a recipient device, a sending device, etc.) used for the conversation channel connection. The subset of the VoIP contextual information relating to the VoIP client device may include audio related information that may be needed to process audio data generated by the VoIP client device. The audio related information may include information related to the device's audio functionality and capability, such as sampling rate, machine type, output/input type, microphone, digital signal processing (DSP) card information, and the like. The subset of the VoIP contextual information relating to the VoIP client device may include video related information that may be needed to process video data generated by the VoIP client device. The video related information may include resolution, refresh, type, and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a device type class 820 may be defined as a subtree structure of a VoIP namespace 800 that includes nodes corresponding to audio 822, video 824, text 825, device specific 826, and the like.

With reference to FIG. 8F, a block diagram of a VoIP client class 830 is depicted. In accordance with an illustrative embodiment, a VoIP client class 830 may correspond to a subset of contextual information relating to VoIP clients. In one embodiment, the subset of the VoIP contextual information relating to the VoIP client may include voice profile information, digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules (defined by the client, a service provider, a network, etc.), user preferences, client preferences, digital rights management (DRM), a member rank of an individual user in an organization, priority associated with the member rank, and the like. The priority associated with the member rank may be used to assign priority to the client for a conference call. In one embodiment, a VoIP client class 830 may be defined as a subtree structure of a VoIP namespace 800 that includes nodes corresponding to biometrics 831, location 832, rules 833, identification 834, member priority 835, client preference 836, and the like.

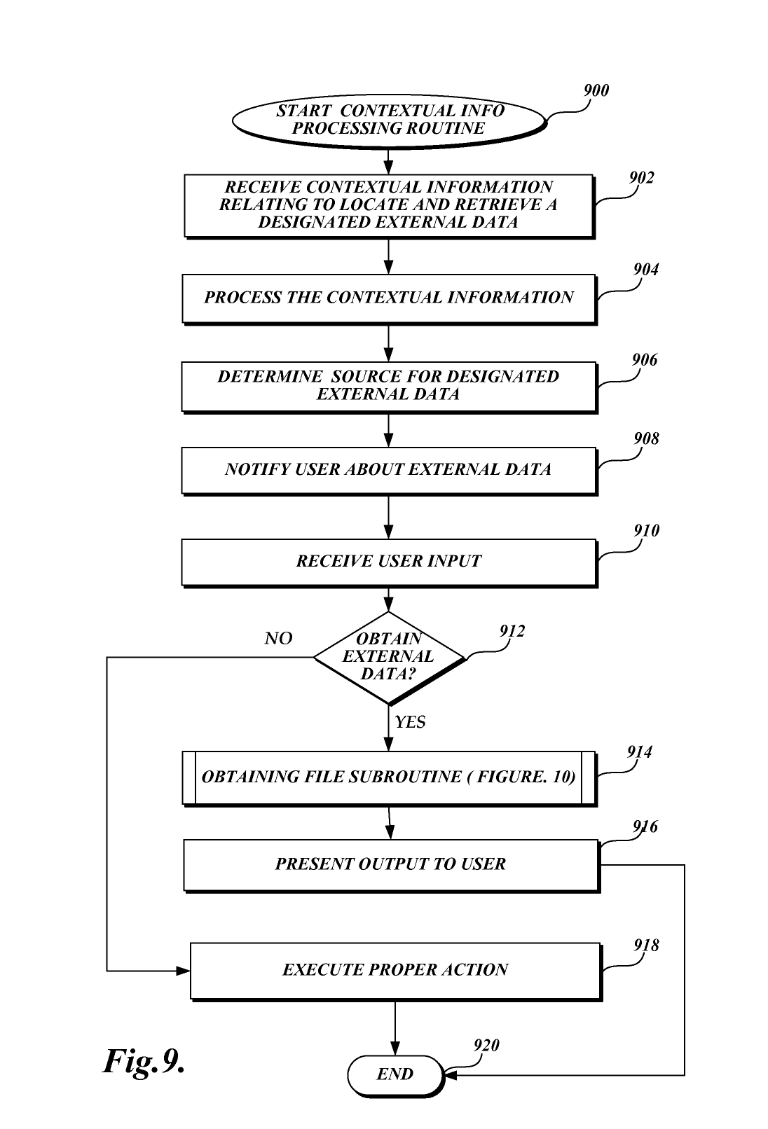

FIG. 9 is a flowchart illustrating a routine 900 for sharing the access information of certain external data in accordance with an embodiment of the present invention. As described above, the external data is a set of data, including, but not limited to, a file, a Web page, and an application, stored in a third party to a communication channel. For discussion purposes, assume that a device of a sending client (a sending device) may have an existing communication channel with a device of a recipient client (a recipient device) and the sending client and the recipient client can access a company Web server which includes a group directory with various electronic documents.

Beginning at block 902, the recipient device may receive from the sending device contextual information including access information for external data. The contextual information includes information relating to locating and retrieving the external data. For example, the sending client and the recipient client are preparing an agenda for an important meeting. During the conversation, the sending client wishes to share a presentation file (PPP.file) which was previously created by the sending party with the recipient client. Although the PPP.file can be transmitted over a digital conversation, the size of the PPP.file is undesirably large, which may lead to a degradation of the quality of the conversation by burdening the bandwidth of the communication channel of the digital conversation. Thus, the contextual information is transmitted, including the access information for the PPP.file which is currently stored in the Web server, to the recipient client.

It is to be understood that the sending client can be any VoIP entity that is capable of transmitting contextual information as part of a conversation. As described above, based on the content of the contextual information, the sending client identifies at least one structured hierarchy from predefined structured hierarchies, such as an XML namespace and the like. The recipient device may further obtain the identified structured hierarchies from the device of the sending client.

At block 904, upon receipt of the contextual information, the received contextual information is processed. In an illustrative embodiment, the recipient device may have a set of rules that define how the contextual information is to be processed on the device. The set of rules corresponding to the contextual information may be identified and utilized to process the contextual information. The set of rules may have been predefined by the recipient client, the service provider, or other authorized VoIP entity.

At block 906, a source for the external data is identified based on the processed contextual information. For example, the URL address of the Web server, the domain name of Web server, an IP address of the Web server, etc., may be identified. At block 908, the recipient device may notify the recipient client about the external data and the Web server. At block 910, a user input with respect to the external data is received. In some instances, the receiving client may not wish to access or retrieve the external data as the sending client suggested. The receiving client may instruct the recipient device to perform a desirable action under the circumstance. In addition, as will be appreciated by one of ordinary skill in the art, several options may be presented within a user interface for the receiving client to choose whether or not to obtain the external data.

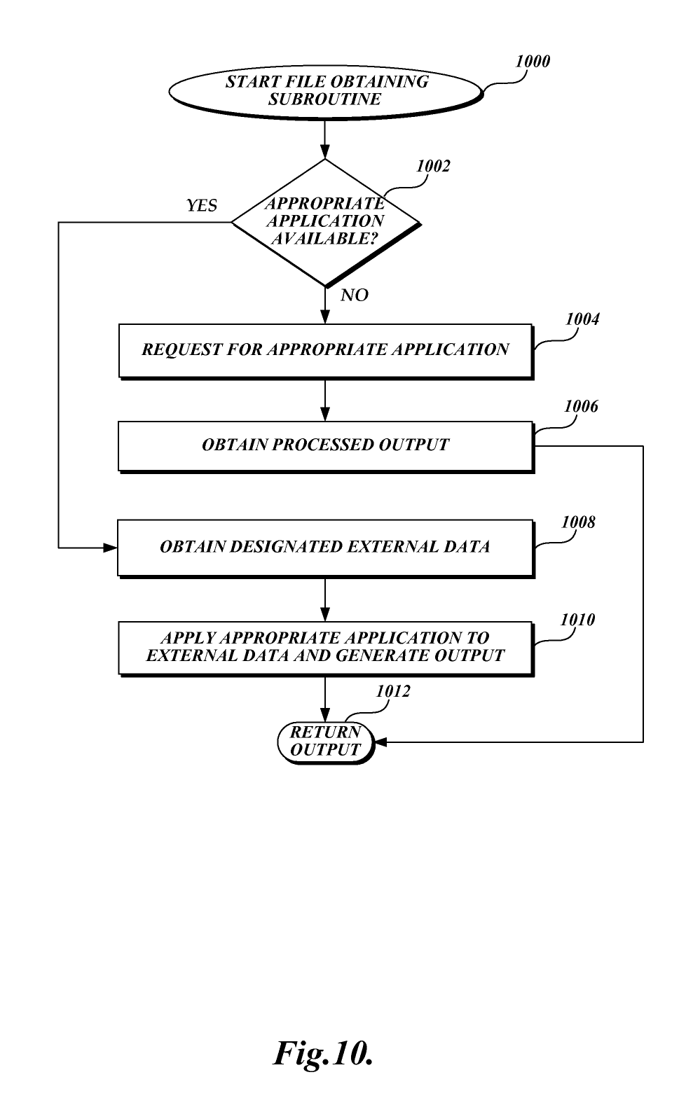

At decision block 912, a determination is made as to whether the external data is to be obtained by the recipient device. If it is determined at decision block 912 that the external data is to be obtained, at block 914, the external data is obtained and is returned via a file obtaining subroutine in FIG. 10. As will be discussed in greater detail below, the file obtaining subroutine 1000 may apply appropriate applications to the external data and produce an output suitable for the recipient device to handle. Returning back to the above mentioned example, the access information may indicate that Microsoft Power Point® may be the proper application to display the external data, the PPP.file. In this example, Microsoft Power Point® may be applied to the PPP.file. Subsequently, the recipient device presents the external data in a proper output format (output) as illustrated at block 916. It is to be understood that any suitable output, including, but not limited to, an audio message, text, multimedia content, a specific format document, a Web page, etc., will be presented to the individual user. In one embodiment, the recipient device may provide a sophisticated user interface which allows the user to navigate, manipulate, and/or update the output based on the need of the user.

If it is determined at decision block 912 that the external data is not to be obtained, at block 918, the recipient device may execute a proper action based on the instruction from the recipient client. For example, the instruction may indicate that a request to obtain the external data may be sent to a proper device of the recipient client that is currently available and capable of retrieving and displaying the external data. For another example, the instruction may indicate that the contextual information will be sent to the sending device, in order to notify that the external data will not be retrieved.

Returning again to the above mentioned example, the sending client may provide the access information including a hyperlink which will activate the presentation material on a Web page of the Web server. Upon receipt of the access information, the recipient device will display the hyperlink in a suitable format to access the presentation material. The recipient client may activate (e.g., click) the hyperlink to view the presentation material. Subsequently, the recipient device may launch a Web browser to receive the Web page of the Web server. After presenting the output (block 916) or executing a proper action (block 918), the routine 900 will complete at block 920.

It is to be understood that the embodiments explained in conjunction with the routine 900 are provided merely for example purposes. It is contemplated that the routine 900 can also be performed by the device of a sending client, a service provider, or a third party service provider that is capable of receiving contextual information and accessing the external data. It is further contemplated that the contextual information including the access information may be exchanged at any time, including before establishing a communication channel (e.g., during a connection set-up phase), during a conversation, or after terminating a communication channel. In addition, it is contemplated that the external data can be stored in devices of the sending client, a service provider, a central data repository, etc. The recipient device may obtain the external data in such a way not to overburden the communication channel. For example, the recipient device may establish a separate connection with the source to obtain the external data.

In one embodiment, the access information may be forwarded from the recipient device to another device which is most appropriate to process the external data. For the purpose of discussion, assume a scenario where a first client is using a device with limited functionalities, for example a mobile phone, and is communicating with a second client. During a conversation, the second client may wish to send contextual information including video data to the first client. The mobile phone which the first client is currently using for the communication channel does not have a software application, or other capabilities, to display the video data. Thus, the first client has specified a set of contextual information processing rules for the mobile phone, indicating that the access information relating to a video file should be forwarded to a personal computer when the mobile phone receives such information.

Upon receipt of the access information of the presentation material, the mobile phone of the first client applies an appropriate set of rules to the access information. As a result, the mobile phone of the first client forwards the access information to the designated personal computer with a request to retrieve the presentation material from the server. Subsequently, the personal computer obtains the presentation material. The personal computer displays the presentation material on its screen. The first client can continue the conversation using the mobile phone while reviewing the presentation on a different device (i.e., a personal computer). Alternatively, the mobile phone may search for a proper device of the first client that is currently available and capable of retrieving and displaying the instant presentation material. The mobile phone may temporarily store the access information in local storage while the search is in progress. Following a successful search, the access information will be forwarded to the located device of the first client.

FIG. 10 is a flowchart illustrating a subroutine 1000 for obtaining external data in accordance with an embodiment of the present invention. In an illustrative embodiment, a device of a sending client (a sending device) may have established a communication channel connection with one of the devices of a recipient client (a recipient device). As with FIG. 9, for the purpose of discussion, assume that the recipient device has received user input instructing it to obtain the external data which is an electronic file stored in the source. At decision block 1002, a determination is made as to whether an appropriate application is available. If it is determined that an appropriate application is available, at block 1008, the electronic file is obtained from the source based on the access information. At block 1010, the recipient device applies the appropriate application on the obtained electronic file to produce an output which can be presented on the recipient device.

For example, the access information includes a location where an image file is stored (e.g., group1/project alpha/XXX), the name of the image file (e.g., photo.jpg), the IP address of the Web server, and the like. Based on the access information, the recipient device can determine that an application suitable for processing the Joint Photographic Experts Group (JPEG) file format may be needed for generating the output of the image file. If such an application is available, the recipient device may connect to the Web server, navigate the path (e.g., group1/project alpha/XXX), and retrieve photo.jpg from the Web server. The application suitable for processing the Joint Photographic Experts Group (JPEG) file format is applied to photo.jpg. The image compressed within photo.jpg will be generated as an output.

In an illustrative embodiment, the access information may include information about a hyperlink of a Web document, a URL address of the Web server, and the like. The recipient device is currently connected to the Internet. It is contemplated that a user interface will be presented to provide the access information in such a way that the recipient client can receive the external data as intended by the sending client. Thus, the hyperlink may be presented in a proper form on the recipient device. When the hyperlink is selected, the Web document associated with the hyperlink will be received from the Web server and displayed via a Web browser. If the hyperlink does not work, the recipient device may connect to the URL address of the Web server to allow the recipient client to navigate the Web server. The recipient client may then manually find the Web document on the Web server.

If it is determined at decision block 1002 that an appropriate application is not available, at block 1004, the recipient device may request that the source apply an appropriate application. At block 1006, the processed output will be received by the recipient device. Alternatively, the recipient device may obtain the appropriate application from the source, other devices of the recipient client, etc. After obtaining the appropriate application, the recipient device retrieves the electronic file and applies the appropriate application to the electronic file to generate output. As discussed above, the output is presented to the recipient client such that the recipient client can manipulate the output via the recipient device. After receiving the processed output (block 1006) or generating the output (block 1010), the subroutine 1000 returns the output and completes at block 1012. In this embodiment, upon identifying an appropriate application, the recipient device requests to obtain the appropriate application from other devices of the recipient client, or a third party.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for sharing external data while a digital conversation is exchanged over a VoIP communication channel, comprising:
receiving access information as part of contextual information over the VoIP communication channel, the access information being related to the external data;
upon receipt of the access information, identifying a source of the external data based on the access information; and
obtaining the external data from the identified source via another communication channel.

2. The method of claim 1, further comprising:
based on the obtained external data, generating an output suitable for a recipient device.

3. The method of claim 2, wherein generating output includes:
based on the access information, identifying an application suitable for the external data; and
applying the application to the external data.

4. The method of claim 1, further comprising:
if the external data cannot be obtained, storing the access information in memory for a delayed access to the external data.

5. The method of claim 4, further comprising:
transmitting a notification which indicates whether the external data can be obtained;
wherein the notification is embedded in contextual information over the digital voice conversation.

6. The method of claim 1, wherein the access information includes a link which is configured to activate the external data to be received and presented.

7. The method of claim 6, wherein the external data is a web document and the link is a hyperlink in connection with the web document.

8. The method of claim 7, wherein the external data is an electronic document and the link is a shortcut link which allows access to the electronic document within the source.

9. A computer-readable medium having computer-executable components for receiving and processing access information over a first communication channel, comprising:
a communication component for receiving contextual information including access information corresponding to external data;
a user interface component for providing the access information to a user and for receiving an input about the user's choice regarding the access information;
a processing component for identifying a set of rules based on the received contextual information and locating and obtaining the external data from a source according to the set of rules; and
wherein the communication component contacts the source to obtain the external data via a second communication channel.

10. The computer-readable medium of claim 9, further comprising:
a storage component for storing the received contextual information and the obtained external data.

11. The computer-readable medium of claim 9, wherein the processing component identifies an appropriate application which is suitable for the obtained external data.

12. The computer-readable medium of claim 11, wherein the communication component obtains the appropriate application from a proper source if the appropriate application is not locally available; and wherein the communication component applies the appropriate application to the obtained external data if the appropriate application is locally available.

13. The computer-readable medium of claim 9, wherein the processing component identifies other external data to share and collects access information corresponding to the other external data; and wherein the communication component transmits the access information corresponding to the identified external data over the first communication channel.

14. The computer-readable medium of claim 13, wherein the processing component further identifies a set of rules related to the access information and the communication component transmits the set of rules over the first communication channel.

15. The computer-readable medium of claim 9, wherein the user interface component presents the output of the external data to the user and receives user inputs in response to the output of the external data.

16. A method for sharing first data and second data stored in a third party via a minimum amount of information exchange over a digital voice conversation with a VoIP client, comprising:
collecting a first set of contextual information relating to access information of first data, wherein the first set of contextual information includes a minimum set of information necessary to obtain and process the first data;
transmitting the first set of contextual information to the VoIP client over the digital conversation;
receiving a second set of contextual information from the VoIP client, the second set of contextual information relating to access information of second data over the digital conversation, wherein the second set of contextual information includes a minimum set of information necessary to obtain and process the second data; and
identifying an appropriate application to process the second data.

17. The method of claim 16 further comprising:
if the appropriate application is available, obtaining the second data from the third party, and applying the appropriate application to the obtained second data.

18. The method of claim 17 further comprising:
if the appropriate application is not available, forwarding the second set of contextual information to a device which includes the appropriate application.

19. The method of claim 16 further comprising:
generating a user interface corresponding to the obtained second data, wherein the user interface is suitable for navigating the obtained second data.

20. The method of claim 16 further comprising:
receiving a request for additional information from the VoIP client; and
in response to the request, providing the additional information to the VoIP client.
